(19) United States
(12) Patent Application Publication
(10) Pub. No.: US 2017/0259317 A1
(43) Pub. Date: Sep. 14, 2017

(54) SYSTEM TO COMPENSATE DEFORMATIONS IN PRESS BENDING MACHINES

(71) Applicant: ADIRA - METAL FORMING SOLUTIONS, S.A., Canelas - Vila Nova de Gaia (PT)

(72) Inventors: Cristiano Jose PEREIRA COUTINHO, Viana Do Castelo (PT); Tiago Maria CARVALHO CUNHA DE BRITO E FARO, Porto (PT); Rui Manuel DA SILVA CESAR, Porto (PT); Antonio DA SILVA ALVES, Pedorido (PT); Fernando GOMES DE ALMEIDA, Vila Nova De Gaia (PT); Joao Paulo GERALDES TOURO PEREIRA, Porto (PT)

(21) Appl. No.: 15/519,616

(22) PCT Filed: Oct. 15, 2015
(86) PCT No.: PCT/IB2015/057937

§ 371 Date: Apr. 17, 2017

(30) Foreign Application Priority Data
Oct. 17, 2014 (PT) 107971

(51) Int. Cl. B21D 5/02; B30B 15/00

(52) U.S. Cl. CPC B21D 5/0272; B30B 15/007

(57) ABSTRACT

The present application describes a system to compensate deformations in press bending machines, in particular press bending machines used for plate conformation or bending, which comprises a group of uprights (1) for supporting the upper apron (7) of the press bending machine, wherein each upright (1) comprises two beams (2,3) placed on the upper and lower ends of a pillar (4) being coupled thereof by means of fastening means (5) and a compensation actuator (6) placed between the beams (2,3) and coupled to the beam (3) at one end thereof. The presented technology allows to increase the distance between the aprons of the press bending machine and the upright scye (1) so that said press bending machine allow the plate deformation in various shapes and dimensions.

### TECHNICAL FIELD

The present application describes a system to compensate deformations in press bending machines.

### STATE OF THE ART

WO 2013/072859 A1 discloses a modifier device of the press bending machine apron's deformation, driven by at least two main actuators, functionally placed between the two aprons.

### SUMMARY

The present application describes a system to compensate deformations in press bending machines that comprises a group of uprights where each upright comprises two beams placed on the upper and bottom end of a pillar, at least one pillar and a compensation actuator placed between the beams and coupled to the beam or to the beam at one end thereof and a deformation measuring system comprised of a sensor, a converter, a numerical control command and an amplifier.

In one embodiment, the beams of the deformation's compensation system in press bending machines couple to the pillar by means of fastening means.

In another embodiment, the fastening means used in the system for the deformation's compensation in press bending machines is screws.

In yet another embodiment of the system to compensate deformations in press bending machines, the sensor (through the action of the converter), numerical control command and amplifier drives the compensation actuator.

In one embodiment, the system's compensation actuator to compensate deformations in press bending machines is actuated in its upper segment.

In another embodiment, the system's compensation actuator to compensate deformations in press bending machines exerts its action over one end of the beam or to the beam opposite to the end that is coupled to the upper apron.

In yet another embodiment, the system's compensation actuator to compensate deformations in press bending machines is hydraulic, mechanical or electrical.

### GENERAL DESCRIPTION

The present application describes a system to compensate deformations in press bending machines, particularly in press bending machines used in plate conformation or bending, that comprises a group of uprights supporting the upper apron of the press bending machine, where each upright comprises two beams placed on the upper and lower ends of a pillar being coupled thereof by means of fastening means and a compensation actuator placed between the beams coupled to the beam—as illustrated—or to the beam at one end thereof.

The technology now presented allows to optimize the distance between the aprons of the press bending machine as well as the distance between them and the cava of the upright i.e. create a zone or scye of dimensions that can be regulated so that said press bending machine allows the plate deformation in various shapes and dimensions, in particular with regard to the width of the flap to bend, by simply modifying the length of the beams in equal length for each side of the pillar.

### DESCRIPTION OF THE FIGURES

For easier understanding of the art the attached figures are joined, which represent preferred embodiments that, however, are not intended to limit the subject of the present application.

FIG. 1: Schematic representation of the system to compensate deformations in press bending machine, in which the following reference numbers represent:

1—Upright;

5—Fastening means;

7—Upper apron.

FIG. 2: Schematic representation of the system to compensate deformations in press bending machine, in which the following reference numbers represent:

1—Upright;

2,3—Beams;

4—Pillar;

5—Fastening means;

6—Actuator;

7—Upper apron.

FIG. 3: Schematic representation of the system to compensate deformations in press bending machine, in which the following reference numbers represent:

1—Upright;

7—Upper apron;

8—Hydraulic cylinders;

9—Upper segment of the compensation actuator;

10—Bottom apron.

FIG. 4: Schematic representation of a press bending machine with various components of the system to compensate deformations in press bending machine.

FIG. 5: Schematic representation of the system to compensate deformations in press bending machine, in which the following reference numbers represent:

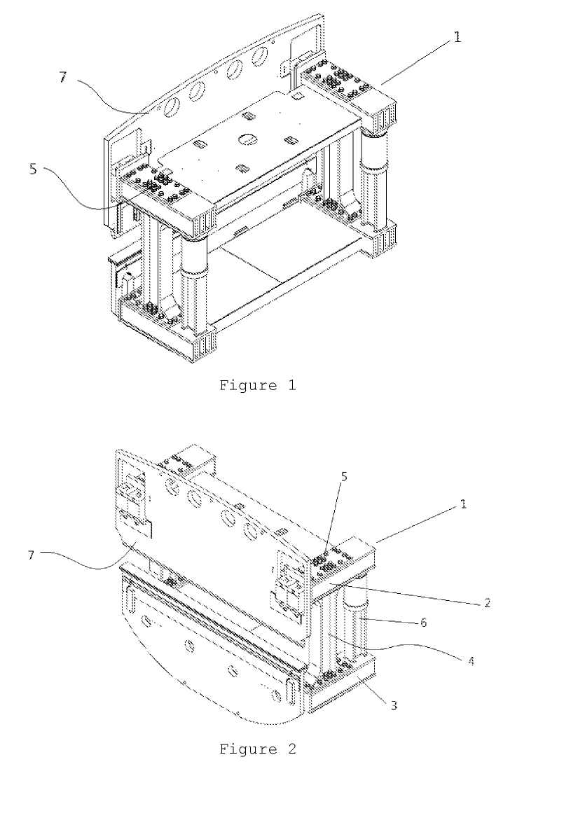

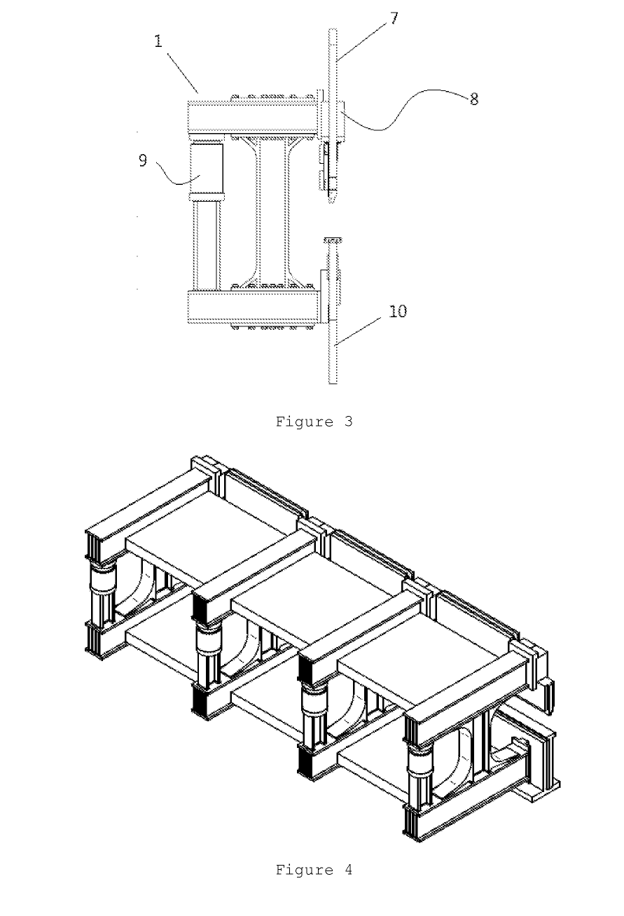

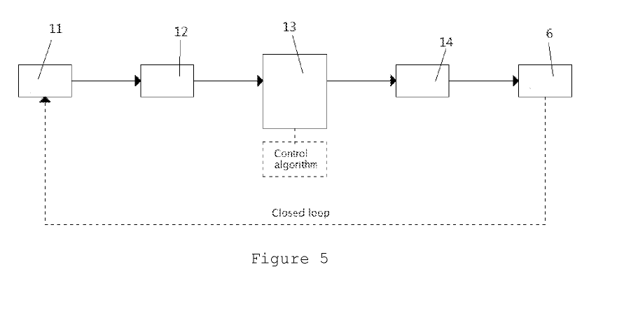

6—Actuator;

11—Sensor;

12—Converter;

13—Numerical control command;

14—Amplifier.

### DESCRIPTION OF EMBODIMENTS

The present application describes a system to compensate deformations in press bending machines, particularly of press bending machines used in plate conformation or bending, that comprises a group of uprights (1) for supporting the upper apron (7) of the press bending machine, with each upright (1) comprising two beams (2,3) placed on the upper and bottom ends of a pillar (4) being coupled thereof by means of fastening means (5) and a compensation actuator (6) placed between the beams (2,3) and coupled to the beam (3)—as illustrated—or to the beam (2) at one end thereof.

The technology now presented allows optimizing the distance between the aprons of the press bending machine as well as the distance between them and the scye of the upright (1) i.e. create a zone or scye, of dimensions that can be regulated so that said press bending machine allows the deformation of plate of various shapes and dimensions, in particular as regards to the width of the flap to bend simply by modifying the length of the beams (2,3) in equal length for each side of the pillar (4).

In normal operation, the upper apron (7) coupled to the beam (2) of the upright (1) moves in the direction from top to bottom by action of the hydraulic cylinders (8) exerting pressure on the plate to bend. The forces exerted in that movement tend to deform the structure of the press bending machine and of the upright (1) itself, particularly on the beam (2) and pillar (4), typically in a range between 0 and 5 degrees, whereby, must be compensated by the action of the compensation actuator (6).

In order to enable compensating the deformation caused by the normal operation of the press bending machine, a system to measure the induced deformation is proposed, comprised by a sensor (11)—for example, strain gauge, optical fibre or laser—that informs the press bending machine controller, by the converter's action (12), numerical control command (13)—that acts by action of a control algorithm—and an amplifier (14), which triggers the compensation actuator (6), in particular its upper segment (9) which exerts its action over one of the beam ends (2), opposite to the end that is coupled to the upper apron (7), i.e. against the direction of the effort. That is, the sensor (11), by the converter's action (12), numerical control command (13) and amplifier (14) triggers the compensation actuator (6).

In order to allow adequate rigidity of the beams (2,3) and its connection to the pillar (4), these are coupled to said pillar (4) by means of a mechanical connection, such as for example by means of screws, this solution allowing to share the stress concentration, as well as ease of assembly and disassembly of the system. With this coupling solution, the loss of resistance to fatigue of the pillar (4) is negligible, and the improvement of the static and fatigue strength of the beams (2,3) and of the upright (1) as a whole is significantly enhanced.

It should be noted that the compensation actuator (6) might be hydraulic, mechanical or electrical.

The present technology allows resizing press bending machines to allow its action on the larger plates, both in length and in width of the flap to bend, simply by resizing the size of the scyes and the number of uprights (1), as illustrated in FIG. 4. This solution allows eliminating the existence of gap to the bottom apron (10), with the consequent cost reduction in terms of system assembly.

The present technology is of course not in any way restricted to the embodiments described herein and a person skilled in the area can provide many possibilities of modification to the technology without departing from the general idea as defined in the claims.

All embodiments described above are obviously combinable with each other. The following claims further define preferred embodiments.

1. System to compensate deformations in press bending machines comprising a group of uprights where each upright comprises two beams placed on an upper and lower ends of a pillar, at least one pillar and a compensation actuator placed between the beams and coupled to the beam or to the beam at one end thereof and a deformation's measurement system comprised of a sensor, a converter, a numerical control command and an amplifier.

2. System to compensate deformations in press bending machines according to claim 1 wherein the beams are coupled to the pillar by means of fastening means.

3. System to compensate deformations in press bending machines according to claim 2 wherein the fastening means are screws.

4. System to compensate deformations in press bending machines according to claim 1 wherein the sensor, through the action of the converter, numerical control command and amplifier triggers the compensation actuator.

5. System to compensate deformations in press bending machines according to claim 1 wherein the compensation actuator is actuated in its upper segment.

6. System to compensate deformations in press bending machines according to claim 5 wherein the compensation actuator exerts its action over one of the ends of the beam or the beam opposite to the end that is coupled to the upper apron.

7. System to compensate deformations in press bending machines according to claim 1 wherein the compensation actuator is hydraulic, mechanical or electrical.
